(19) United States
(12) Patent Application Publication
(10) Pub. No.: US 2004/0052689 A1
(43) Pub. Date: Mar. 18, 2004

(54) Self-sealing materials and devices comprising same

(75) Inventor: Li Yao, Peachtree City, GA (US)

Correspondence Address: JONES DAY, 51 Louisiana Aveue, N.W, WASHINGTON, DC, 20001-2113, US

(73) Assignee: Porex Technologies Corporation

(21) Appl. No.: 10/603,765

(22) Filed: Jun. 26, 2003

Related U.S. Application Data
(62) Division of application No. 09/375,383, filed on Aug. 17, 1999, now abandoned.

(51) Int. Cl. B01L 3/02

(52) U.S. Cl. 422/100

(57) ABSTRACT

This invention relates to gas- or liquid-permeable materials that seal when exposed to water and methods of making such materials. In general, materials of this invention comprise a hydrogel adhered to pore walls of a porous substrate.

The invention further relates to devices comprising self-sealing materials including, but not limited to, pipette tips, containers, intravenous liquid delivery systems, and syringe caps.

### 1. FIELD OF THE INVENTION

The invention relates to gas- or liquid-permeable materials that seal when exposed to water, methods of making such materials, and devices made from or comprising such materials.

### 2. BACKGROUND OF THE INVENTION

The ability of a gas- or liquid-permeable material to seal (i.e., become less permeable) when exposed to water is of great use in a variety of filtering and venting applications. One application is the venting of air from syringes. The use of a self-sealing vent in this case can allow the expulsion of air from a syringe while preventing the expulsion of its contents, which may be hazardous. Another application is the prevention of sample overflow in pipettes. Other potential applications of self-sealing materials include, but are not limited to, ventilation of liquid storage and/or delivery systems such as intravenous drug delivery systems.

In order for a self-sealing material to be useful in a wide range of applications, it must respond (i.e., seal) quickly when exposed to water, cause little or no contamination of aqueous solutions with which it comes in contact, and be capable of withstanding high back-pressures (e.g., greater than about 7 psi) before again allowing the passage of gas or liquid. If the material is to be used in medical applications, it must further be biocompatible, i.e., free of potentially toxic chemicals.

U.S. Pat. No. 4,340,067 discloses a syringe having a bypass element that allegedly allows the expulsion of air, but prevents the expulsion of blood. The bypass element is made of a hydrophilic material that swells when exposed to water. Although the hydrophilic materials that are disclosed (i.e., porous filter papers and copolymers of polyvinyl chloride (PVC) and acrylonitrile) do absorb water to some extent, they do so too slowly to be of much use in other applications. Further, because PVC copolymers are made using free-radical processes, they typically contain trace amount of initiators, monomers, plasticizers, and other toxic molecules and are thus not biocompatible.

U.S. Pat. Nos. 4,924,860, 5,125,415, and 5,156,811 disclose self-sealing materials that operate by a different mechanism. These materials are made of a porous plastic filled with particles of a water-absorbable material such as cellulose. Although U.S. Pat. No. 4,924,860 alleges that such particles swell when wet, thereby blocking the pores of the plastic, it is believed that cellulose power instead dissolves in water to form a highly viscous solution.

Self-sealing materials made of porous plastic and cellulose powder tend to withstand higher back-pressures as the amount of powder they contain is increased, and materials that contain 20 weight percent or more of cellulose powder are not uncommon. Unfortunately, because the powder is not adhered to the plastic substrate, these self-sealing materials can easily contaminate liquids with which they come in contact. This contamination is aggravated by the high water solubility of most cellulose powders. Contamination can also result from a leaching of metal or other ions from cellulose powders. For example, sodium carboxyl methyl cellulose, which is commonly used in self-sealing materials, readily releases sodium ions into water. For these reasons, self-sealing materials containing cellulose powder are unsuited for use in applications that require contaminate-free liquids.

Other disadvantages of cellulose powder-based components exist. For example, because such components contain large amounts of cellulose powder in order to provide sufficient self-sealing, their mechanical strength, which can further decrease upon exposure to water, is insufficient for many applications.

A third type of self-sealing material, which can be used to avoid such severe contamination problems, is disclosed by U.S. Pat. Nos. 4,769,026 and 5,364,595. This material is made of a porous, hydrophobic plastic that has a small average pore size. Unfortunately, this material can withstand only moderate back-pressures before allowing the passage of water. There thus remains a need for new seal-sealing materials.

### 3. SUMMARY OF THE INVENTION

This invention relates to gas- or liquid-permeable materials that seal when exposed to water, methods of making such materials, and devices made from or comprising such materials. In general, materials of this invention comprise a hydrogel adhered to pore walls of a porous substrate.

A first embodiment of the invention encompasses a self-sealing material comprising a hydrogel adhered to pore walls of a porous substrate. Preferably, the hydrogel is a polymer selected from the group consisting of hydrophilic polyurethane, hydrophilic polyurea, and hydrophilic polyureaurethane. More preferably, the hydrogel is hydrophilic polyurethane. Most preferably, the hydrogel is hydrophilic polyurethane made from the reaction of a polyol and a diisocyanate in a molar ratio of from about 80:100 to about 20:100, more preferably from about 70:100 to about 40:100, and most preferably from about 65:100 to about 50:100.

Depending upon the particular application for which the self-sealing material is to be used, the porous substrate it comprises can be made of any material not soluble in water including, but not limited to: metals, metal oxides, and alloys; ceramics; inorganic and organic materials such as graphite, glass, paper, and organic polymers; and mixtures thereof. Preferred porous substrates are organic polymers. Examples of specific organic polymers include, but are not limited to: acrylic polymers; polyolefins such as, but not limited to, polyethylene and polypropylene; polyesters; polyamides such as nylon; poly(ether sulfone); polytetrafluoroethylene; polyvinyl chloride; polycarbonates; and polyurethanes. More preferred substrate materials are polyolefins.

A second embodiment of the invention encompasses a process for making a self-sealing material and the product of that process, which process comprises forming a mixture comprising a hydrogel material and a substrate material and heating the mixture to the sintering temperature of the substrate material to form a porous substrate, wherein the sintering temperature is greater than the melting point of the hydrogel material.

Preferably, the hydrogel material is selected from the group consisting of hydrophilic polyurethane, hydrophilic polyurea, and hydrophilic polyureaurethane. More preferably, the hydrogel material is hydrophilic polyurethane.

Preferably, the porous substrate material is selected from the group consisting of: acrylic polymers; polyolefins such as, but not limited to, polyethylene and polypropylene; polyesters; polyamides such as nylon; poly(ether sulfone); polytetrafluoroethylene; polyvinyl chloride; polycarbonates; and polyurethanes. More preferably, the porous substrate material is a polyolefin.

A third embodiment of the invention encompasses a process for making a self-sealing material and the product of that process, which process comprises immersing at least part of a porous substrate in a solution comprising a non-aqueous solvent and a hydrogel material.

Preferably, the non-aqueous solvent is selected from the group consisting of ethers such as tetrahydrofuran; and alcohols such as methanol, ethanol, and isopropanol. More preferably, the non-aqueous solvent is ethanol or methanol.

Preferably, the hydrogel material is selected from the group consisting of hydrophilic polyurethane, hydrophilic polyurea, and hydrophilic polyurethane. More preferably, the hydrogel material is hydrophilic polyurethane.

A fourth embodiment of the invention encompasses a process for making a self-sealing material and the product of that process, which process comprises immersing at least a part of a porous substrate in a solution comprising at least one reactant under conditions suitable for the formation of a hydrogel material within pores of the porous substrate. The solution can, if desired, further comprise a solvent.

Preferably, the at least one reactant is a prepolymer formed by the reaction of a polyol and a diisocyanate. More preferably, diisocyanate is purified by distillation. More preferably, the at least one reactant further comprises at least one of a catalyst and a chain extender.

A fifth embodiment of the invention encompasses a process for making a self-sealing material and the product of that process, which process comprises coating fibers of a support material with a hydrogel and assembling the coated fibers in such a way as to form a porous substrate.

A sixth embodiment of the invention encompasses a pipette tip which comprises: a hollow tube open at opposite first and second ends; a self-sealing plug member comprised of a hydrogel adhered to pore walls of a porous substrate; and a means of attaching the first end of the hollow tube to a suction device. Preferably, the hydrogel is made of hydrophilic polyurethane. Preferably, the porous substrate is made of a polyolefin. The invention further encompasses pipettes comprising the pipette tips of the invention.

A seventh embodiment of the invention encompasses a container for holding a liquid which comprises: an inner surface; an outer surface; and a self-sealing vent comprised of a hydrogel adhered to pore walls of a porous substrate, wherein gas or non-aqueous liquid can pass from the inner surface to the outer surface through the vent. Preferably, the hydrogel is made of hydrophilic polyurethane. Preferably, the porous substrate is made of a polyolefin.

An eighth embodiment of the invention encompasses an intravenous liquid delivery system which comprises: a container; a tube; a needle; and a self-sealing vent operatively attached to one another, wherein the self-sealing vent is comprised of a hydrogel adhered to pore walls of a porous substrate. Preferably, the hydrogel is made of hydrophilic polyurethane. Preferably, the porous substrate is made of a polyolefin.

A ninth embodiment of the invention encompasses a cap for facilitating purging of gas from a syringe containing liquid and gas which comprises: a tubular housing open at opposite first and second ends; a self-sealing plug member comprised of a hydrogel adhered to pore walls of a porous substrate; and a means of attaching the first end of the hollow tube to a syringe. Preferably, the hydrogel is made of hydrophilic polyurethane. Preferably, the porous substrate is made of a polyolefin.

### 3.1 BRIEF DESCRIPTION OF THE DRAWINGS

Self-sealing materials of the invention can be used in a wide variety of applications and can be incorporated into innumerable devices. Some of these applications and devices can be better understood with reference to the figures described below:

FIG. 1A illustrates a pipette tip of the invention;

FIG. 1B illustrates a pipette of the invention;

FIG. 1C illustrates a top view of a pipette tip of the invention;

FIG. 1D illustrates a second pipette tip of the invention;

FIG. 1E illustrates a third pipette tip of the invention;

FIG. 2A illustrates a container of the invention;

FIG. 2B illustrates the use of a container of FIG. 2A;

FIG. 3A illustrates a intravenous delivery system of the invention;

FIG. 3B illustrates an adaptor of the delivery system of FIG. 3A;

FIG. 4A illustrates a syringe cap of the invention;

FIG. 4B illustrates a syringe to which a syringe cap of the invention can be attached;

FIG. 4C illustrates a syringe cap of the invention attached to a syringe; and

FIG. 4D illustrates an alternative syringe cap of the invention attached to a syringe.

### 4. DETAILED DESCRIPTION OF THE INVENTION

This invention relates to materials that are permeable to gases or non-aqueous liquids but which become less permeable when exposed to water. These materials, referred to herein as “self-sealing” materials, comprise a hydrogel adhered to pore walls of a porous substrate. A hydrogel is a material that swells in water and retains a significant fraction of water without dissolving in water. Hydrogels are made of at least one hydrophilic polymer, referred to herein as a “hydrogel material.”

Self-sealing materials of this invention can exhibit a number of desirable properties, including short response times, little or no contamination of aqueous solutions with which they come in contact, the ability to withstand high back-pressures, and biocompatibility. Preferred self-sealing materials of the invention can withstand a water back-pressure of greater than about 7 psi, more preferably greater than about 8 psi, and most preferably greater than about 8.5 psi. The air flow rate of preferred self-sealing materials under an air pressure of 1.2 inches water is greater than about 16 ml/minute, preferably greater than about 18 ml/minute, and more preferably greater than about 20 ml/minute.

The mechanical, physical, and chemical properties of a self-sealing material of the invention can be adjusted by the appropriate selection of the substrate and hydrogel materials and the process used to make the self-sealing material. Without being limited by theory, it is believed that these properties result from an ability of some hydrogels to rapidly swell when exposed to water while remaining adhered to a porous substrate.

### 4.1. Porous Substrates

Porous substrates from which self-sealing materials can be made are insoluble in water and contain one or more channels through which gas or liquid molecules can pass. Porous substrates can be made by any method known to those skilled in the art including, but not limited to: sintering; the use of blowing agents and/or leaching agents; microcell formation methods such as those disclosed by U.S. Pat. Nos. 4,473,665 and 5,160,674, both of which are incorporated herein by reference; drilling, including laser drilling; and reverse phase precipitation. Depending on how it is made, a porous substrate can thus contain regular arrangements of channels of random or well-defined diameters and/or randomly situated pores of varying shapes and sizes. Pore sizes are typically referred to in terms of their average diameters, even though the pores themselves are not necessarily spherical.

The particular method used to form the pores or channels of a porous substrate and the resulting porosity (i.e., average pore size and pore density) of the porous substrate can vary according to the desired application for which the final self-sealing material will be used. For example, small diameter pores or channels are preferred in cases where rapid self-sealing is desired and/or high back pressures are anticipated, while larger diameter pores or channels may be preferred in cases where small pressure gradients across the self-sealing material are desired prior to sealing. The desired porosity of the substrate can also be affected by the substrate material itself, as porosity can affect in different ways the physical properties (e.g., tensile strength and durability) of different materials.

A preferred porous substrate of this invention has an average pore size of from about 10 μm to about 40 μm, more preferably from about 15 μm to about 35 μm, and most preferably from about 20 μm to about 30 μm. Mean pore size and pore density can be determined using, for example, a mercury porosimeter, scanning electron microscopy, or atomic force microscopy.

Porosity and other factors such as manufacturing cost and resistance to corrosion or decomposition are preferably considered when choosing the material(s) from which a porous substrate is made. Depending upon the particular application for which the self-sealing material is to be used, the porous substrate it comprises can be made of any material not soluble in water including, but not limited to: metals, metal oxides, and alloys; ceramics; and inorganic and organic materials such as graphite, glass, paper, and organic and organometallic polymers; and mixtures thereof. Examples of metals, metal oxides, and alloys include, but are not limited to, Group IIIB, IVB, VB, VIB, VIIB, VIII, IB, IIB, IIIA, and IVA metals and oxides and alloys thereof. Specific metals include, but are not limited to, aluminum, titanium, chromium, nickel, copper, zinc, molybdenum, palladium, silver, copper, zinc, tungsten, platinum, and gold. Examples of alloys include, but are not limited to, stainless steel. Examples of ceramics include, but are not limited to, silica carbide, clays, and oxides of magnesium. Examples of papers include, but are not limited to, woven and non-woven cotton fiber based, glass fiber based, cellulose based, and carbon fiber based. Organic polymers useful as substrates, include, but are not limited to: atactic and syntactic homopolymers; copolymers, including statistical, random, alternating, periodic, block, and graft copolymers; and regular and irregular single-strand and double-strand polymers. Examples of specific organic polymers include, but are not limited to: acrylic polymers; polyolefins such as, but not limited to, polyethylene and polypropylene; polyesters; polyamides such as nylon; poly(ether sulfone); polytetrafluoroethylene; polyvinyl chloride; polycarbonates; and polyurethanes. Preferred substrate materials are polyolefins.

The porous substrate can be made of single-component materials, multi-component materials such as laminates, and woven and non-woven fibrous materials. Examples of fibrous materials include, but are not limited to, those made of acrylic, polyesters, polyolefins, glass, and mixtures thereof. Particularly preferred porous substrates are made of polyolefins.

Although the particular substrate used to prepare a self-sealing material will depend on a variety of factors, typical porous substrates are made of porous high density polyethylene having a mean pore size of from about 15 to about 50 μm. Examples of such materials have part nos. X-6837, P-6516, and P-5973 and are available from Porex Technologies Corp., Fairburn, Ga.

### 4.2. Hydrogels

Selection of the hydrogel should account for the porosity and composition of a porous substrate. This is because, for example, different hydrogels can adhere differently to a particular substrate. Other factors to be considered when selecting a hydrogel include, but are not limited to, the amount of water it can absorb, its rate of water absorption, how much it expands when it absorbs water, its solubility in, for example, non-aqueous solvents that may come into contact with the final self-sealing material, its thermal stability, and its biocompatibility.

The bulk physical and chemical properties of a hydrogel depend on the physical and chemical properties of the specific hydrogel materials (i.e., polymers) from which it is made. To be specific, the bulk properties of a hydrogel made from a given hydrogel material depend on the average molecular weight, crystallinity, and crosslinking of the hydrogel material. For example, the durability and toughness of a hydrogel typically increase with increased crosslinking density, but the same increased density can limit the ability of a hydrogel to rapidly expand and absorb water. Preferred hydrogels of the invention are not chemically crosslinked, as crosslinked hydrogels are typically stiff and hard. Preferred hydrogels are, however, somewhat crystalline when hydrated: this crystallinity, which can provide stability and integrity, is sometimes referred to as physical crosslinking.

Hydrogels used to provide the self-sealing materials of the invention can be adhered to the pore walls of porous substrates, thereby affording materials that are substantially free of loose particulate matter. Possible adhesion mechanisms include van der Waals interactions, and covalent, ionic, and hydrogen bonding. Although not necessary for all applications, hydrogels of the invention are preferably biocompatible.

Hydrogel materials include, but are not limited to, hydrophilic polyurethane, hydrophilic polyurea, and hydrophilic polyureaurethane. A preferred hydrogel material is hydrophilic polyurethane. Depending on its manufacture, hydrophilic polyurethane is sticky and adheres strongly to surfaces, is biocompatible, and is capable of absorbing large amounts of water (e.g., up to about 4000 weight percent). Hydrophilic polyurethanes suitable for use in the invention include, but are not limited to: Tecogel™ 2000, Tecogel™ 500, and Tecophilic™ 150, available from Thermedics Inc., Woburn, Mass.; and Hydrothane™, available from CT Biomaterials, Woburn, Mass.

Hydrophilic polyurethane can also be manufactured by reacting a diisocyanate, a hydrophilic polyol, and optionally a chain extender. In this reaction, the molar ratio of diisocyanate to the sum of hydrophilic polyol and chain extender used to prepare hydrophilic polyurethane is theoretically 1:1. It is preferred, however, that a slight excess of diisocyanate be used. This is because some diisocyanate can react with moisture in the air, and because excess diisocyanate can react with synthesized polyurethane to provide some branching that can increase the mechanical strength of the resulting hydrophilic polyurethane.

The specific reactants, molar ratios, and reaction conditions used to prepare a hydrophilic polyurethane will typically be selected with reference to its desired mechanical and chemical properties. For example, the hydrophilicity of a polyurethane can be varied by increasing the relative amount of polyol used in its synthesis and/or by increasing the average molecular weight of the polyol. To be specific, if high molecular weight (e.g., from about 8,000 to about 20,000 g/mol) polyethylene glycol (PEG) is used, the molar ratio of PEG to diisocyanate can be very low (e.g., from about 20:100 to about 10:100) while the molar ratio of chain extender to diisocyanate can be high (e.g., from about 80:100 to about 90:100). The resulting hydrophilic polyurethane has high water absorption and mechanical strength but a low water absorption rate due to chain entanglement and crystallinity.

If medium molecular weight (e.g., from about 1,000 to about 4,000 g/mol) PEG is used to provide a hydrophilic polyurethane, the molar ratio of PEG to diisocyanate should be high in order to provide for acceptable water absorption, but the molar ratio of chain extender to diisocyanate can be low (e.g., from about 80:100 to about 90:100). The resulting hydrophilic polyurethane has high water absorption and a high water absorption rate, but has inferior mechanical strength.

In a third example of how the reactants and their ratios can be varied to provide hydrophilic polyurethanes with different physical properties, high molecular weight PEG is used in conjunction with a high PEG-to-diisocyanate ratio, thereby providing a hydrophilic polyurethane with high water absorption, a high water absorption rate, and extremely low mechanical strength.

In general, hydrophilic polyurethane used to prepare self-sealing materials of the invention is made with a hydrophilic polyol to diisocyanate ratio of from about 80:100 to about 20:100, more preferably from about 70:100 to about 40:100, and most preferably from about 65:100 to about 50:100. A chain extender is also preferably used during the synthesis in a molar ratio of chain extender to hydrophilic polyol of from about 20:100 to about 80:100, more preferably from about 30:100 to about 60:100, and most preferably from about 35:100 to about 50:100.

Examples of hydrophilic polyols that can be used to make hydrophilic polyurethane include, but are not limited to, poly(alkylene)glycols, polyester-based polyols, and polycarbonate polyols such as those described in U.S. Pat. No. 5,777,060, which is incorporated herein by reference. Poly(alkylene)glycols include polymers of lower alkylene glycols such as poly(ethylene)glycol, poly(propylene)glycol, and polytetramethylene ether glycol (PTMEG).

Polyester-based polyols include, but are not limited to, those of Formula 1:

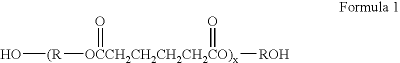

wherein x is an integer and R is a lower alkylene group such as, but not limited to, ethylene, 1,3-propylene, 1,2-propylene, 1,4-butylene, and 2,2-dimethyl-1,3-propylene. Polyester-based polyols further include those with structures analogous to that of Formula 1 wherein the adipic acid moiety is replaced with, for example, a succinic acid ester, a glutaric acid ester, or derivatives thereof.

Polycarbonate polyols include, but are not limited to, those of Formula 2:

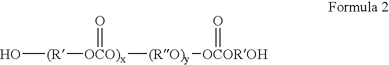

wherein R′ is a cyclic, branched, or linear alkane, R″ is an alkane, and each of x and y is independently an integer.

A preferred hydrophilic polyol used for the preparation of hydrophilic polyurethane is polyethylene glycol, more particularly a polyethylene glycol having an average molecular weight of from about 600 g/mol to about 20,000 g/mol, more preferably from about 2000 g/mol to about 10,000 g/mol. Preferred hydrophilic polyols include PEG-1000, PEG-4000, PEG-6000, and PEG-8000 sold by Baker Mallinckrodt, Inc., Philipsburg, N.J.

Examples of diisocyanates useful in the preparation of hydrophilic polyurethane include, but are not limited to, those disclosed by U.S. Pat. No. 5,786,439, which is incorporated herein by reference. Both aliphatic and aromatic diisocyanates can be used. Suitable aliphatic diisocyanates include, but are not limited to, 4,4′-methylenebis-(cyclohexylisocyanate), (H₁₂MDI), 1,6-hexamethylene diisocyanate (HDI), trimethylhexamethylene diisocyanate (TMDI), trans-1,4-cyclohexane diisocyanate (CHDI), 1,4-cyclohexane bis(methylene isocyanate) (BDI), 1,3-cyclohexane bis(methylene isocyanate) (H₆XDI), and isophorone diisocyanate (IPDI). Examples of suitable aromatic diisocyanates include, but are not limited to, toluene diisocyanate, 4,4′-diphenylmethane diisocyanate (MDI), 3,3′-dimethyl-4,4′-biphenyl diisocyanate, naphthalene diisocyanate, and paraphenylene diisocyanate. Preferred diisocyanates are HDI and MDI. A number of these diisocyanates are available from commercial sources such as Aldrich Chemical Company, Milwaukee, Wis., or can be readily prepared using methods known to those skilled in the art.

Examples of chain extenders useful in preparation of hydrophilic polyurethane include, but are not limited to, short chain diamines and diols. Examples of preferred chain extenders include, but are not limited to, 1,2-diaminocyclohexane, butenediol, and hexenediol. These compounds are also available from commercial sources such as Aldrich Chemical Company.

The preparation of hydrophilic polyurethane typically comprises two steps. In the first, a prepolymer is formed by reacting the diisocyanate and polyol. This reaction can be done with or without solvent: the use of a solvent can allow better control of the molecular weight and/or intrinsic viscosity of the hydrophilic polyurethane, but solvents are preferably not used in the large-scale production of hydrophilic polyurethane. Suitable solvents include, but are not limited to, toluene, ethers such as tetrahydrofuran, ketones such as acetone, dimethyl formamide, dimethyl sulfoxide, and methylene chloride.

The reaction is preferably facilitated by the addition of a catalyst, preferably a tin complex such as dibutyltin-bis(ethyl hexanoate), and is carried out under an inert atmosphere such as nitrogen gas at a temperature of from about 55° C. to about 85° C., preferably from about 60° C. to about 75° C., and more preferably from about 65° C. to about 70° C. The reaction is allowed to run until the desired amount of prepolymer is formed. Typical reaction times are from about 1 hour to about 4 hours, more preferably from about 1.5 hours to about 3.5 hours, and most preferably from about 2 hours to about 3 hours.

In the second reaction step, a chain extender is added to the pre-polymer reaction mixture. The resulting reaction mixture is preferably maintained at a temperature of from about 70° C. to about 85° C., more preferably from about 75° C. to about 85° C., and most preferably from about 75° C. to about 85° C. The reaction is allowed to proceed until the desired amount of hydrophilic polyurethane is formed. Typical reaction times are from about 3 hours to about 8 hours, more preferably from about 4 hours to about 6 hours. If a solvent is used, the hydrophilic polyurethane can be isolated from it upon completion of the reaction by evaporation of the solvent or by precipitation and filtration. Hydrophilic polyurethane can be precipitated by addition of water to the reaction mixture.

### 4.3. Preparation of Self-Sealing Materials

At least four general processes can be employed to provide self-sealing materials of the invention: in the first, the porous substrate is formed at the same time as the self-sealing material itself; in the second, the hydrogel material is simply adhered to the porous substrate; in the third, the hydrogel material is formed within the porous substrate; and in the fourth, the hydrogel material is adhered to strands or fibers of substrate material which are then compressed, chemically linked, or woven together.

In a first process of preparing self-sealing materials of the invention, a mixture is formed comprising a hydrogel material and a substrate material, wherein the materials are preferably in powder form and wherein the melting temperature of the hydrogel material is less than the sintering temperature of the substrate material. The mixture is heated to the sintering temperature of the substrate material powder, thereby forming the porous substrate while at the same time coating the pores with the melted hydrogel material. The self-sealing material is obtained upon cooling, and can then be cut into pieces of desired shape. Alternatively, the mixture can be combined in a mold of suitable shape. The use of molds is preferred where the desired shape of the self-sealing material is complex.

This first process offers advantages of economy, as the hydrogel material (which yields the hydrogel upon cooling) is adhered to the pore walls of the porous substrate at the same time the solid substrate is formed. This process can also provide the uniform coating of pore walls with hydrogel since each pore is formed in the presence of molten hydrogel material. Uniform coatings are desired because they help ensure an evenly distributed flow of gas or liquid across a self-sealing material as well as evenly distributed sealing when the material is exposed to water. A further advantage provided by this process is that large amounts of hydrophilic polyurethane can be incorporated within the porous matrix of the support.

This process does require, however, the careful matching of hydrogel and support materials to ensure that the hydrogel material melts but does not burn or decompose at the sintering temperature of the support material. Support materials that can be used in this method include plastics such as, but not limited to, polyethylene, polypropylene, polyester, nylon, poly(ether sulfone), polytetrafluoroethylene, polyvinyl chloride, polycarbonate, and polyurethane. Preferred support materials are polyolefins (e.g., polyethylene and polypropylene), and particularly preferred support materials are polyolefins that melt at about 120° C.

In a second process, a porous substrate is immersed or dipped in a solution comprising a non-aqueous solvent into which hydrogel material has been dissolved. Preferably, the solution comprises hydrogel material in an amount of from about 5 to about 30 weight percent, more preferably from about 10 to about 25 weight percent, and most preferably from about 10 to about 20 weight percent. The porous substrate is kept immersed in solution until those pores to be coated with hydrogel have been filled. The substrate is then taken out of the solution and the solvent it contains is removed by blow air drying and/or heating optionally under a vacuum. As the solvent is removed, the hydrogel material is deposited on the walls of the substrate pores.

A particular benefit of this process is that it allows production of self-sealing materials comprising pores and/or channels of sizes, size distributions, or shapes that cannot be formed by sintering. This process further allows production of self-sealing materials from substrate materials, such as metals and organic fibers, that cannot be sintered under conventional conditions or in the presence of relatively low-melting point hydrogel materials. This process can pose problems, however, if the hydrogel solution is so viscous that it cannot enter the pores of the substrate. Fortunately, viscosity problems can be minimized to some extent by a variety of techniques including, but not limited to, heating the hydrogel solution, forcing the hydrogel solution into the porous substrate under pressure, lowering the concentration of hydrogel material, and multiple treatments (e.g., immersions of the porous substrate into a hydrogel solution).

The hydrogel solution can comprise any non-aqueous solvent in which the hydrogel material is soluble and the substrate material is insoluble. Preferred solvents thus depend on the particular hydrogel and substrate material used. For example, if the hydrogel is hydrophilic polyurethane and the porous substrate is made of a polyolefin, suitable solvents include, but are not limited to, ethers such as tetrahydrofuran and alcohols such as methanol, ethanol, and isopropanol.

A third process for the preparation of self-sealing materials can be used to overcome the viscosity problems of the second process described above. According to this process, hydrogel material is synthesized within the pores of a porous substrate by immersing or dipping the porous substrate in a reaction mixture under reaction conditions (e.g., time and temperature) that will yield hydrogel material. In this way, the reactants, which tend to be small and have little effect on the viscosity of the mixture, combine within individual pores to form hydrogel material. When the reaction is complete, most if not all pores will contain hydrogel material. Often, this material will be too large or inflexible to leave a pore even if dissolved in a non-aqueous solvent. In many cases, the substrate can thus be quickly washed with certain non-aqueous solvents as well as with water in order to remove unreacted starting material and catalyst. The substrate is then allowed to dry, during which time the hydrogel material adheres to the walls of the pores.

For example, a self-sealing material can be made by immersing a porous substrate in a solution comprising a prepolymer synthesized from a polyol, excessive diisocyanate, and optionally a catalyst in relative amounts such as are described above in Section 4.2. The solution can further comprise a non-aqueous solvent such as, but are not limited to, toluene, ethers such as tetrahydrofuran, ketones such as acetone, dimethyl formamide, dimethyl sulfoxide, and methylene chloride. A preferred solvent is tetrahydrofuran. After the porous substrate is coated with prepolymer solution, it is cured by dipping into a chain extender, or a solution comprising a chain extender, to form within the pores long, rigid polymer molecules. Finally, the substrate is washed with water and/or non-aqueous solvent, which is then removed by evaporation.

A fourth process of preparing self-sealing materials of the invention is useful when the porous substrate comprises woven or non-woven fibers. In this process, the fibers of a support material (e.g., nylon, cellulose fiber, or any other natural or synthetic fiber) are coated with the desired hydrogel. This can be accomplished by dipping the fibers in a hydrogel material solution, such as described above, or by using any method known to those skilled in the art. The resulting coated fibers are then woven or stuck together by methods such as, but not limited to, compression, chemical bonding, sintering, and binding by thermoset resins (e.g., water-based phenolic resins). The particular method used will depend upon the hydrogel and substrate materials and on the end use of the self-sealing material. A preferred method, chemical bonding, is only useful if biocompatibility of the self-sealing material is not required.

### 4.4. Self-Sealing Devices

The self-sealing materials of this invention can be incorporated into innumerable and varied devices. These include, but are not limited to, containers, pipette tips, intravenous liquid delivery systems, and syringe caps. Other potential uses for, and devices comprising, the self-sealing materials disclosed herein include, but are not limited to, the protection of tranducers, ink pen vents, the protection of vacuum pumps and/or systems, the protection of pneumatic components, use in the high speed filling of containers such as those used for batteries and beverages, emergency spill valves for chemical containers such as drums and bottles as well as those used on trains and other vehicles, “burp” or “blow-out” valves, use in the filling of refrigerant, brake, or hydraulic systems, and vents in items such as ink-jet cartridges and disk drives.

Additional uses of the self-sealing materials of the invention will be apparent upon consideration of the following examples.

### 5. EXAMPLES

### 5.1. Example 1

### Synthesis of Hydrophilic Polyurethane

A reaction flask was gently warmed to 30° C. -40° C. under a nitrogen atmosphere using a heating mantle with a temperature indicator. 100 g of 4.4′-diphenylmethane (Aldrich) diisocyanate were fed into the reactor. The flask was then heated to 80° C. as the contents were stirred. After the temperature was stable, 1,000 g of PEG-1000 (Aldrich) were added to the reactor. A transparent viscous gel was formed after 10 minutes of stirring, at which time 19.6 g of butanediol (Aldrich) were added to the reaction mixture. The mixture was stirred for an additional 2 minutes while the temperature was maintained at about 85° C. The resulting hot viscous gel was then poured into a metal mold, which was then placed in an oven maintained at about 65° C. for 6 hours. The resulting product was removed from the mold and fed through a twin-screw extender maintained at 85° C. to provide hydrophilic polyurethane which was then pelletized.

The synthesized polyurethane has a melting temperature of about 80° C. and is capable of absorbing from about 1,000 to about 2,000 weight percent water.

### 5.2. Example 2

### Preparation of Self-Sealing Material

Porous ultra high molecular weight polyethylene having an average pore size of 20 to 35 μm (Porex Technologies Corp.) was dipped in an ethanol solution containing 20 percent by weight hydrophilic polyurethane prepared according to Example 1. The porous substrate was kept in the solution for about 5 minutes and then removed and dried first under blowing hot air and then in a conventional oven kept at 65° C. for 2 hours.

### 5.3. Example 3

### Properties of Self-Sealing Materials

Self-sealing materials prepared from ultra high molecular weight polyurethane as in Example 2 exhibit different air flow and back-pressure properties depending on the pore size of the substrate material and the concentration of the hydrophilic polyurethane solution in which it was dipped, as shown below in Tables 1 and 2:

TABLE 1
Airflow Rate (ml/min) under an Air Pressure of 1.2 Inches Water

| Coating Solution | Airflow rate (ml/min) | | |
|---|---|---|---|
| Concentration | 10 (μm) | | |
| (weight percent) | pore size | 25 (μm) pore size | 35 (μm) pore size |
| 0 | 10 | 28 | 29 |
| 10 | 8.0 | 20 | 25 |
| 15 | 7.0 | 18 | 19 |
| 20 | 6.8 | 16.2 | 16 |

TABLE 2
Water Back Pressure (psi)

| | |
|---|---|
| Coating Solution | Water back pressure (psi) |

| Concentration | 10 (μm) | 25 (μm) | 35 (μm) |
|---|---|---|---|
| (weight percent) | pore size | pore size | pore size |
| 0 | 3 | 2 | 1.5 |
| 10 | >7 | >7 | 3.5 |
| 15 | >7 | >7 | 6.0 |
| 20 | >7 | >7 | >7 |

Because perfect sealing typically occurs at about 7 psi, it is clear from Table 2 that self-sealing materials can be provided using substrates of different average pore sizes.

### 5.4. Example 4

### Self-Sealing Pipette Tips

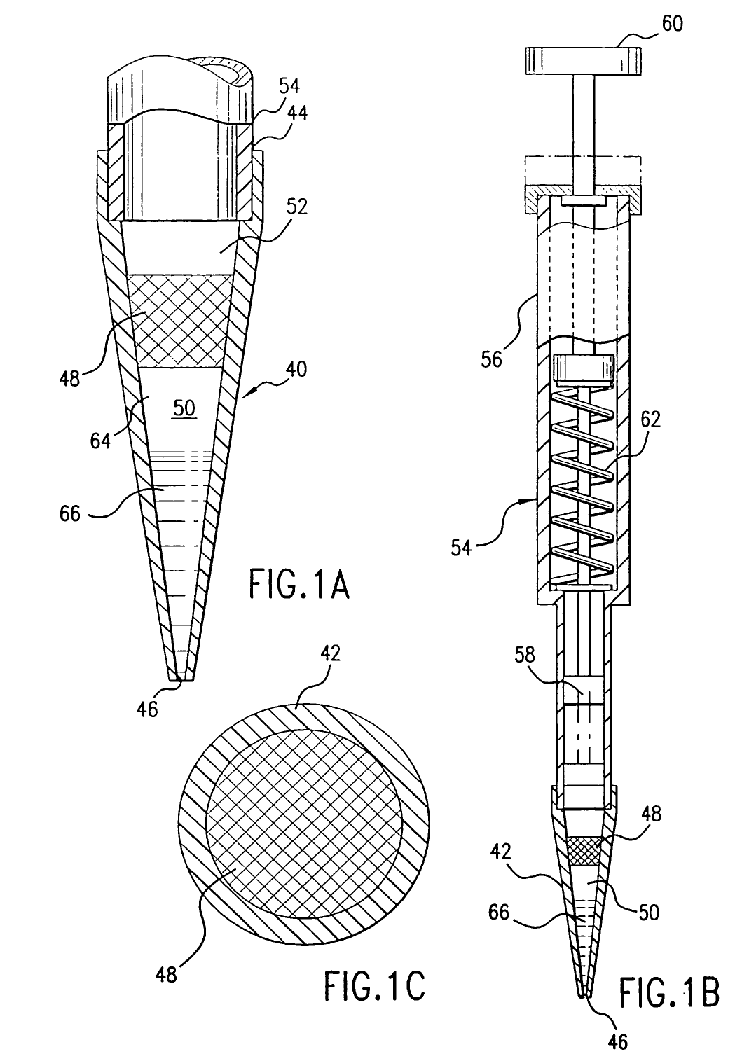

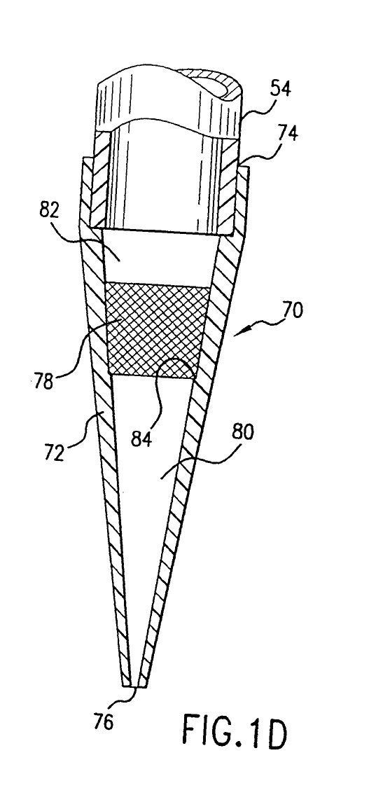

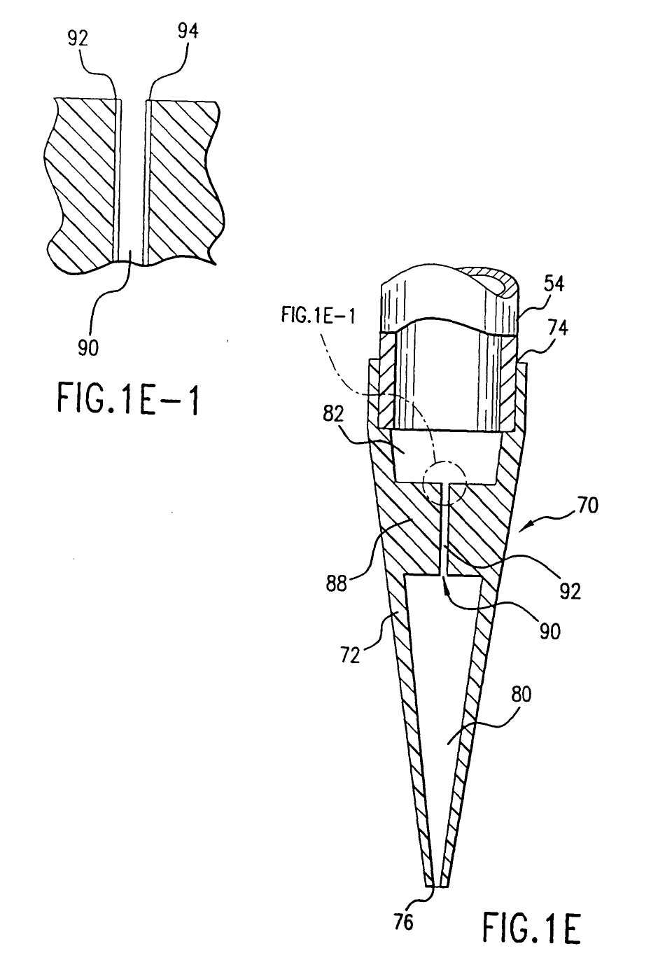

FIGS. 1A to 1E illustrate pipette and pipette tips of the invention. FIGS. 1A and 1B illustrate a pipette tip 40 for drawing and dispensing liquid samples. The pipette tip 40 basically comprises a tapering, hollow tubular member 42 of non-reactive material such as glass, open at its opposite first 44 and second 46 ends and a plug member 48 of the self-sealing material of the invention disposed in the tubular member 42 to define a liquid sample chamber 50 between the plug member 48 and second end 46 of the tube. The plug member is also spaced from the first end 44 of the tube to define an air barrier or chamber 52 between the plug member and end 44 of the tube.

The first end 44 of the tubular member 42 is releasably secured to a suitable suction device 54 in a manner known in the field, as generally illustrated in FIG. 1B. Any suitable suction device for drawing a predetermined volume of liquid into the chamber 50 can be used, such as the volumetric pipettor illustrated in the drawings, or a suction pump, elastic bulb, bellows, or the like as are commonly used to draw liquids in the laboratory analysis field. The suction device 54 illustrated by way of example in FIG. 1B comprises a cylinder or a tube 56 and a piston 58 slidable in tube 56 and attached to a plunger 60 extending out of one end of tube 56 The opposite end of the tube 56 is secured to the first end 44 of the pipette tip 40. Piston 58 is urged upwardly to draw a predetermined volume of liquid equivalent to the piston displacement via return spring 62.

The plug member 48 is preferably force or pressure fitted securely into tube 42, under a sufficient pressure (e.g., about 1800 lb/in²) so that it is securely held and frictionally sealed against the inner wall of tube 42 although not physically attached to the inner wall by any adhesive or other extraneous material. The plug member has a tapering, frusto-conical shape of dimensions matching that of the tube 42 at a predetermined location intermediate its ends, so that the plug member will be compressed as it is forced into the tube and released at the desired position to seal against the inner wall of the tube and define a liquid sample chamber 50 of predetermined dimensions. The liquid sample chamber is arranged to be of predetermined volume greater than the liquid sample volume which will be drawn by one full stroke of the suction device. The dimensions of the chamber 50 beneath plug member 48 are such that there will be a substantial air gap 64 between plug member 48 and a drawn liquid sample 66 to reduce the risk of liquid actually contacting the plug member. The air gap is preferably in the range of from about 10 to about 40 percent of the total volume of chamber 50. Thus, one complete stroke of the suction device will draw only enough liquid to fill from about 60 to about 90 percent of the volume of chamber 50, as indicated in FIG. 1A.

FIG. 1C is a top view of the pipette tip 40. The plug member 48 is formed of a self-sealing material of the invention. A particularly suitable material of the invention comprises hydrophilic polyurethane adhered to pore walls of porous a polyolefin.

In order to draw a liquid sample into pipette tube 54, the suction device or plunger is first depressed or compressed, as appropriate, and the tip end 46 is submerged below the surface of a liquid to be sampled. Any aerosol droplets drawn up into plug member 48 will come into contact with hydrogel adhered within pores of the plug member. The hydrogel in those pores will absorb the liquid and swell to eventually block them. Other pores in plug member 48 will still remain unblocked, however, and allow passage of gas through the plug member 48 to draw in and subsequently eject or blow out the sample. As long as the tubular member 42 is held more or less erect and not tilted or bounced during the sampling process, no liquid will come into contact with plug member 48 because the air gap 52 produced by the predetermined volume of sample chamber 50 is substantially greater than the volume of fluid drawn by one stroke of the suction device. When the sample has been drawn, the pipette and attached pipette tip are transferred carefully to a location above a vessel or sample collector into which the liquid sample is to be ejected for subsequent research or analysis. The sample is held in the tube under suction during this transfer procedure. Once the pipette tip is positioned above the collector, the suction device is actuated to blow gas or air back through the plug member and force the liquid sample out of the pipette.

If for some reason the liquid sample 66 actually contacts the plug member during the sampling procedure, sufficient liquid will be absorbed by the self-sealing material to completely seal the plug member 48 to further passage of gas. Because the self-sealing material does not contaminate the sample, however, the sample need not be discarded. This is of particular importance when samples contain, for example, material that is extremely expensive or difficult to isolate.

FIG. 1D illustrates a modified pipette tip 70 which again comprises a hollow, frusto-conical or tapering tubular member 72 for securing to a suitable pipette or suction device 54 at one end 74 so as to draw a liquid sample into the pipette through the opposite end 76. A plug member 78 which is of the same material as plug member 48 in the embodiment of FIGS. 1A to 1C is force or friction fitted into the member 72 at an intermediate point between its end so as to define a liquid sample chamber 80 on one side and an air barrier chamber 82 on the opposite side of plug member 78. However, in FIG. 1D the inner wall of member 72 is provided with a step or shoulder 84 against which the plug member 78 is seated and which prevents movement of the plug member any further along the bore of tubular member 72. As in the previous embodiment, the sample chamber 80 has a volume substantially greater than that of a liquid sample drawn by one full stroke of the suction device, so that an air gap will be left between a drawn sample and the plug member. The modified pipette tip 70 operates in the same way as the pipette tip 40 of FIGS. 1A to 1C as described above.

FIG. 1E illustrates a pipette tip of the invention which does not comprise a plug member, but instead consists of a center member 88 disposed between a liquid sample chamber 80 and an optional air barrier 82. The center member 88, which can be any shape and can be flat, curved, or tapered at either end, contains at least one pore or channel 90 that allows air to flow from the liquid sample chamber 80 to the optional air barrier 82. The inner wall 92 of the at least one pore or channel 90 is coated partially or entirely with a hydrogel 94. Consequently, the center member, which is simply a part of the pipette tip tubular member 72, acts as a plug member. When an aqueous solution enters the at least one pore or channel 90, the hydrogel 94 swells, thereby closing the at least one pore or channel 90 and preventing contamination of the suction device (e.g., pipette) to which the pipette tip is attached.

Pipette tips of this invention will greatly reduce the risk of contamination of the pipettor or suction device and resultant cross-over contamination to subsequent samples, and will also substantially reduce the risk to personnel when handling potentially infectious or other hazardous materials. Further, unlike other pipette devices, the self-sealing material of the invention provides that when a sample does come into contact with the plug member, the sample is not contaminated by, for example, cellulose powder.

### 5.5. Example 5

### Biocompatible Container

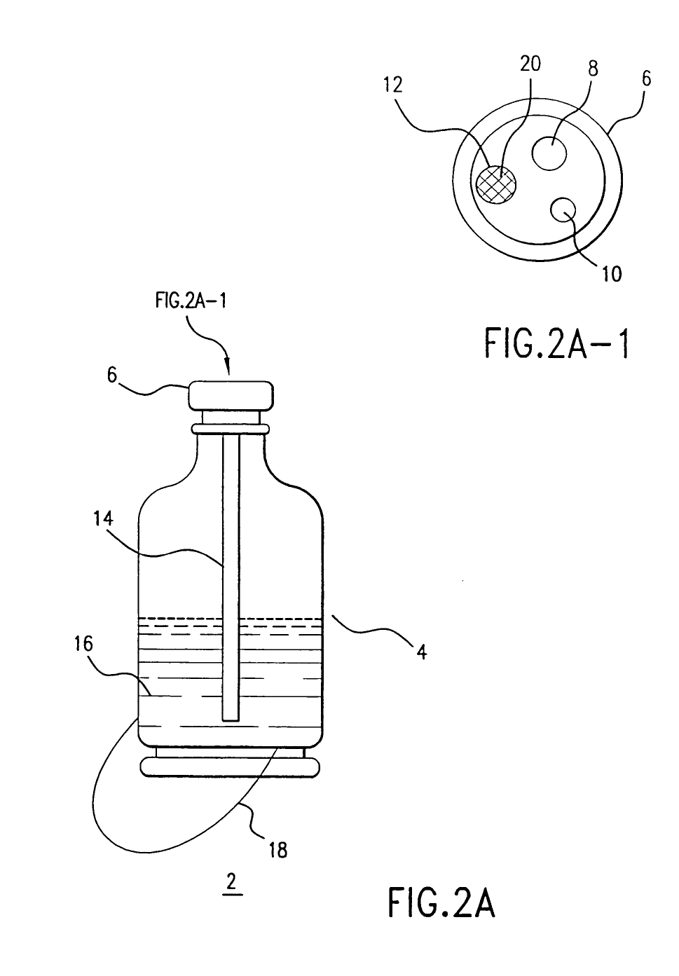

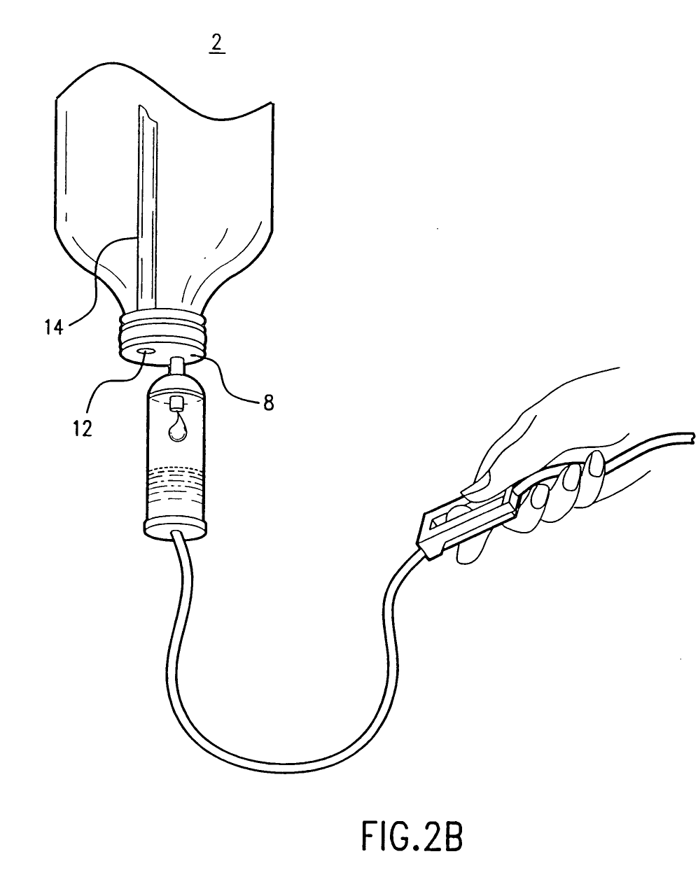

FIG. 2A illustrates a container or liquid storage device of the invention useful in the storage of aqueous solutions suitable for intravenous administration to patients. The container 2 comprises a bottle 4 and a cap 6. The cap, a top view of which is provided, is preferably made of puncture proof aluminum or plastic and contains an administration spike hole 8, an additive injection port 10, and a vent 12. Attached to the vent 12 is a vent tube 14 which allows air to enter the container 2 as its contents 16 are drained. The container 2 is held upside down by a hanger 18.

If it is desired that additives, such as drugs, be administered using the contents 16 of the container 2 as a carrier, such additives can be combined with the contents 16 by their injection through the additive injection port 10. The administration spike hole and additive injection port are typically made of a biocompatible membrane material such as latex. As shown in FIG. 2B, a needle connecting the storage device 2 to the vein of the patient is inserted into the administration spike hole 8. The vent 12 is made of a biocompatible self-sealing material 20 of the invention. It thus allows the exit of air, but prevents escape of the container contents 16 should the container 2 be jarred. Because the vent is biocompatible, however, the contents are not rendered unsafe simply because they came in contact with the vent material 20.

### 5.6. Example 6

### Intravenous Fluid Delivery System

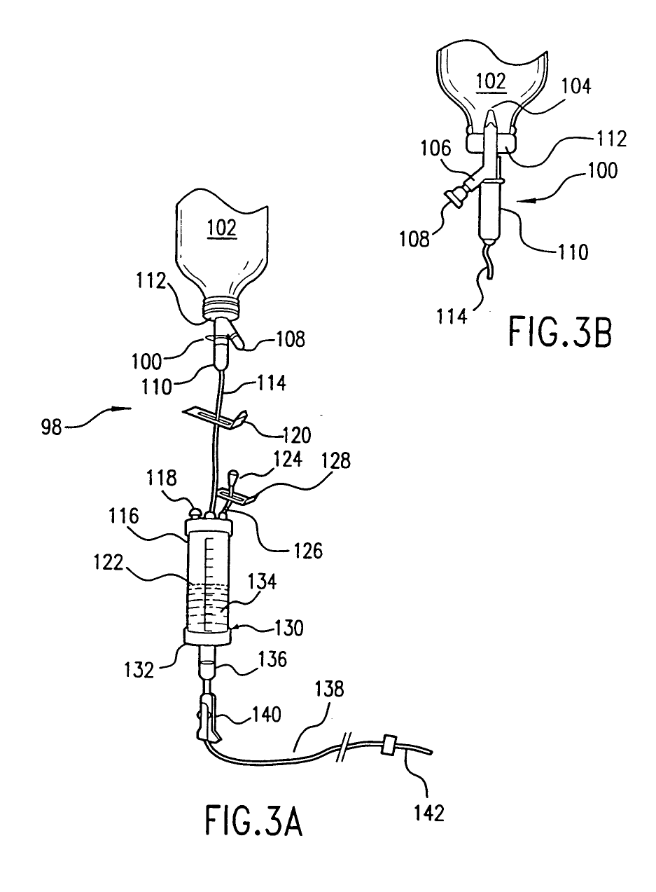

FIGS. 3A and 3B illustrate a basic intravenous fluid delivery system suitable for piggyback administration of a drug that takes advantage of the novel, biocompatible self-sealing materials of the invention.

As shown in FIGS. 3A and 3B, the basic delivery system 98 comprises an adaptor 100 and a primary IV container 102. The contents of the primary IV container 102 can provide fluid replacement, electrolyte replenishment, drug therapy, or nutrition. In this delivery system, the adaptor 100 is a vented adaptor, and comprises a spike 104, an air inlet and ball valve 106, an air filter 108, and a drip chamber 110. The spike 104, which is typically made of biocompatible plastic, pierces the rubber closure or plastic seal 112 of the primary IV container 102. The first drip chamber 110 traps air and permits adjustment of flow rate.

As shown in FIG. 3A, the first drip chamber 110 is attached to tubing 114 which in turn is connected to a volume control chamber 116 which can be used for the piggyback administration of drugs via the injection port 118. A first slide clamp 120 positioned on the tubing 114 between the first drip chamber 110 and the volume control chamber 116 allows the volume control chamber 116 to be filled with a desired amount 122 of fluid from the primary IV container 102. An air vent 124 attached to the volume control chamber 116 via tubing 126 that runs through a second slide clamp 128 helps ensure that liquid can easily be injected through the injection port 118 when the first slide clamp 120 is closed.

At the bottom 130 of the volume control chamber 116 is a filter and/or valve 132 through which the contents 134 of the volume control chamber 116 can pass into a second drip chamber 136. The second drip chamber 136 is connected to tubing 138 that runs through a final clamp 140. The tubing 138 is connected to a needle 142 that is inserted into the vein of a patient.

The entire fluid delivery system 98 is sterile and made of biocompatible materials. Advantageously, one or both of the air filter 108 and the air vent 124 are made of a self-sealing material of the invention. If, due to mechanical failure or accident, the fluid contents of the delivery system come into contact with a filter 108 or vent 124 made of a self-sealing material, the filter 108 or vent 124 will seal and prevent the escape of the fluid. Further, because self-sealing materials of the invention do not contain loose particles such as cellulose powder, the fluid within the delivery system 98 will still be suitable for administration to the patient. Administration of the contents of the delivery system 98 after the filter 108 or vent 124 has sealed can be easily achieved by the simple, low-cost replacement of either.

### 5.7. Example 7

### Syringe Cap

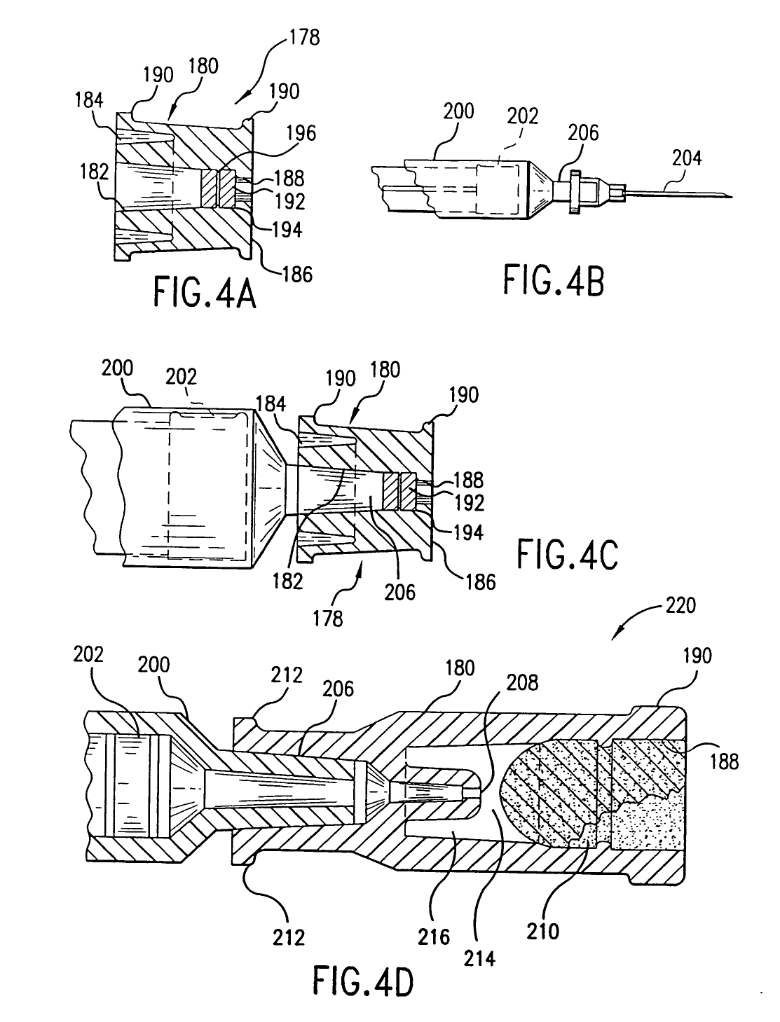

FIGS. 4A to 4D illustrate syringe caps of the invention which can be used to expel air from a filled syringe without expelling its aqueous contents. Syringe caps are of particular use in evacuating air from syringes used to obtain blood samples, especially when those blood samples may contain biohazards.

As shown in FIG. 4A, the main body of a syringe tip cap of the invention 178 is a tubular member 180 of circular transverse cross-section, one end 182 of which is open and fitted on the inside with a groove 184 to accommodate the threaded ring of a luer lock found on some syringes. This end of the member thus defines a fluid-tight connection when it attaches to the male-luer design of a syringe. The other end 186 of the member is virtually closed, except for a vent hole 188 in the middle of the cross-section. Two 360 degree shoulders 190 extend from the virtually closed end 186 of the tubular member 180 and the open end 182 to facilitate handling and manufacturing of the syringe tip cap.

Abutting the interior face of the virtual closed end 186 of the tubular member 180 is a disc-like filter 192. The filter is held in place by making it slightly oversized so that it fits the inner wall of the tubular member 194 tightly. Additionally, notches 196 can be placed on the inside surface of the tubular member section which contacts the filter 192 to ensure a tight fit.

The filter 192 is comprised of a self-sealing material of the invention. A preferred self-sealing material is comprised of hydrophilic polyurethane adhered to pore walls of porous polyolefins. It is preferred that the tubular member 180 be made of a non-reactive clear plastic. The clarity of the plastic enables the operator to visually monitor the wetting of the filter 192.

A syringe 200, shown in FIG. 4B, is of standard tubular design fitted with a plunger 202 slidably received therein so that the inside walls of the tube and the outer edge of the plunger 202 produce a tight fit around the circumference of the plunger 202. Typical use of the syringe 200 exposes the syringe contents (e.g., a blood sample) to air. In order to make use of the syringe cap 178, the needle 204 is unscrewed from the syringe 200 using a sheath after a sample has been taken. The syringe tip cap 178 is then screwed onto the luer 206 of the syringe 200. The male luer lock of the syringe securely mates with the female luer lock 184 of the syringe tip cap. Alternatively, the connection can be secured by a friction fit between the outer circumference of the syringe tip and the inner circumference of the cap. Once the syringe tip cap is set securely onto the syringe luer 206 as shown in FIG. 4C, an airtight fit is obtained. The syringe is held so the filter tip cap 178 is pointing up to cause the air to rise to the luer end. The plunger 202 in the syringe 200 is advanced and the air is expelled from the syringe 200 into the syringe tip cap 178. Because the filter 192 is dry at this time, the air can easily pass through the filter 192 and vent hole 188. Following the air into the syringe tip cap is the leading edge of the syringe contents. The contents are pushed forward through the luer 206 and eventually advance all the way to the filter 192. When the syringe contents contact the filter 192, the filter seals, thereby preventing expulsion of the syringe contents yet doing so without contaminating the contents with, for example, cellulose powder.

FIG. 4D shows an alternative tip cap 220. This embodiment incorporates a cylindrical axial flow restricter or choke 208 that serves to narrow the flow cross-section of the syringe contents (e.g., blood) prior to contacting the filter. Alternative cap 220 further utilizes a convex, or bullet tip, filter 210. This type of filter 210 is configured to reduce the changes of wetting the entire front edge of the filter 210 before all the air is evacuated. Tabs 212 extend outwardly from the tubular member 180. The tabs 212 are used when applicable to engage the threads of a luer lock ring on a syringe.

The narrow diameter of the choke outlet 208 restricts the area of the filter 210 that is initially struck by the syringe contents. A cavity 214 is formed between the choke output 208 and the filter 210. The cavity 214 is extended down around the circumference of the choke 208 to form a reservoir 216. Thus, the central extended part of the filter 210 is aligned with the opening in the choke while the recessed portion of the filter, which in this design is the outer annulus, is recessed away from the opening. The recessed portion of the filter is not exposed to liquid as it is expelled from the choke, but only to liquid as the cavity 214 is filled. The reservoir 216 fills with the initial sample expelled from the choke 208, leaving the outer annulus of the filter 210 dry so that air can escape. Thus, when the luer contents are expelled through the choke 208, some may strike the filter 210 and that which does not wet the filter 210 drops to the sides and collects in the reservoir 216. Because the volume of the reservoir 216 is greater than the volume of the liquid held in the syringe luer, the reservoir 216 is of sufficient size to collect any of the luer contents that do not initially wet the filter 210. The combination of the reservoir 216 and the choke 208 serves to keep major portions of the filter 210 dry until all the air in the syringe 200 has exited the system. Once all the air has exited, the contents of the main body of the syringe 200 enter the syringe tip cap, pass through the choke 208 and into the reservoir 216, and raise the level of the liquid in the reservoir 216 up to the filter 210. When the cavity 214 is filled with liquid, the entire filter 210 surface is wetted and the filter 210 is sealed.

The embodiments of the invention described above are intended to be merely exemplary, and those skilled in the art will recognize, or will be able to ascertain using no more than routine experimentation, numerous equivalents of the specific materials, procedures, and devices described herein. All such equivalents are considered to be within the scope of the invention and are encompassed by the appended claims.

What is claimed is:

1. A self-sealing material comprising a hydrogel adhered to pore walls of a porous substrate.

2. The self-sealing material of claim 1 wherein the hydrogel is a polymer selected from the group consisting of hydrophilic polyurethane, hydrophilic polyurea, and hydrophilic polyureaurethane.

3. The self-sealing material of claim 2 wherein the hydrogel is hydrophilic polyurethane.

4. The self-sealing material of claim 3 wherein the hydrogel is hydrophilic polyurethane made from the reaction of a polyol and a diisocyanate in a molar ratio of from about 80:100 to about 20:100.

5. The self-sealing material of claim 4 wherein the hydrogel is hydrophilic polyurethane made from the reaction of a polyol and a diisocyanate in a molar ratio of from about 70:100 to about 40:100

6. The self-sealing material of claim 5 wherein the hydrogel is hydrophilic polyurethane made from the reaction of a polyol and a diisocyanate in a molar ratio of from about 65:100 to about 50:100.

7. The self-sealing material of claim 1 wherein the porous substrate is made of a material selected from the group consisting of: metals, metal oxides, and alloys; ceramics; inorganic and organic materials; and mixtures thereof.

8. The self-sealing material of claim 7 wherein the porous substrate is made of an organic or organometallic polymer.

9. The self-sealing material of claim 8 wherein the porous substrate is made of an organic polymer selected from the group consisting of: acrylic polymers; polyolefins; polyesters; polyamides; poly(ether sulfone); polytetrafluoroethylene; polyvinyl chloride; polycarbonates; and polyurethanes.

10. The self-sealing material of claim 9 wherein the porous substrate is made of a polyolefin.

11. The self-sealing material of claim 1 wherein the porous substrate is made of a single-component material, a multi-component material, or a woven or non-woven fibrous materials.

12. A process for making a self-sealing material which comprises forming a mixture comprising a hydrogel material and a substrate material and heating the mixture to the sintering temperature of the substrate material to form a porous substrate, wherein the sintering temperature is greater than the melting point of the hydrogel material.

13. The process of claim 12 wherein the hydrogel material is selected from the group consisting of hydrophilic polyurethane, hydrophilic polyurea, and hydrophilic polyureaurethane.

14. The process of claim 13 wherein the hydrogel material is hydrophilic polyurethane.

15. The process of claim 12 wherein the porous substrate material is a polymer selected from the group consisting of: acrylic polymers; polyolefins; polyesters; polyamides; poly(ether sulfone); polytetrafluoroethylene; polyvinyl chloride; polycarbonates; and polyurethanes.

16. The process of claim 15 wherein the porous substrate material is a polyolefin.

17. A product of the process of claim 12.

18. A process for making a self-sealing material which comprises immersing at least part of a porous substrate in a solution comprising a non-aqueous solvent and a hydrogel material.

19. The process of claim 18 wherein the non-aqueous solvent is selected from the group consisting of ethers and alcohols.

20. The process of claim 19 wherein the non-aqueous solvent is ethanol or methanol.

21. The process of claim 18 wherein the hydrogel material is selected from the group consisting of hydrophilic polyurethane, hydrophilic polyurea, and hydrophilic polyurethane.

22. The process of claim 21 wherein the hydrogel material is hydrophilic polyurethane.

23. A product of the process of claim 18.

24. A process for making a self-sealing material which comprises immersing at least a part of a porous substrate in a solution comprising at least one reactant under conditions suitable for the formation of a hydrogel material within pores of the porous substrate.

25. The process of claim 24 wherein the at least one reactant is a prepolymer formed by reacting a polyol and a diisocyanate.

26. The process of claim 25 wherein the at least one reactant further comprises at least one of a catalyst and a chain extender.

27. A product of the process of claim 24.

28. A process for making a self-sealing material which comprises coating fibers of a support material with a hydrogel and assembling the coated fibers in such a way as to form a porous substrate.

29. A pipette tip which comprises: a hollow tube open at opposite first and second ends; a center member disposed between said opposite first and second ends; and a means for attaching the first end of the hollow tube to a suction device, wherein said center member comprises at least one pore or channel having an inner wall coated partially or completely with a hydrogel.

30. A pipette tip which comprises: a hollow tube open at opposite first and second ends; a self-sealing plug member disposed between said opposite first and second ends; and a means for attaching the first end of the hollow tube to a suction device, wherein said self-sealing plug member comprises a hydrogel adhered to pore walls of a porous substrate.

31. The pipette tip of claim 29 or 30 wherein the hydrogel is made of hydrophilic polyurethane.

32. The pipette tip of claim 30 wherein the porous substrate is made of a polyolefin.

33. A pipette comprising the pipette tip of claim 29 or 30.

34. A container for holding a liquid which comprises: an inner surface; an outer surface; and a self-sealing vent comprised of a hydrogel adhered to pore walls of a porous substrate, wherein gas or non-aqueous liquid can pass from the inner surface to the outer surface through the vent.

35. The container of claim 34 wherein the hydrogel is made of hydrophilic polyurethane.

36. The container of claim 34 wherein the porous substrate is made of a polyolefin.

37. An intravenous liquid delivery system which comprises: a container; a tube; a needle; and a self-sealing vent operatively attached to one another such that liquid can pass from the container and thru the tube and needle, wherein the self-sealing vent is comprised of a hydrogel adhered to pore walls of a porous substrate.

38. The intravenous liquid delivery system of claim 37 wherein the hydrogel is made of hydrophilic polyurethane.

39. The intravenous liquid delivery system of claim 37 wherein the porous substrate is made of a polyolefin.

40. A cap for facilitating purging of gas from a syringe containing liquid and gas which comprises: a tubular housing open at opposite first and second ends; a self-sealing plug member disposed between said opposite first and second ends and comprised of a hydrogel adhered to pore walls of a porous substrate; and a means for attaching the first end of the hollow tube to a syringe.

41. The cap of claim 40 wherein the hydrogel is made of hydrophilic polyurethane.

42. The cap of claim 40 wherein the porous substrate is made of a polyolefin.
